(19) United States
(12) Patent Application Publication
(10) Pub. No.: US 2017/0021390 A1
(43) Pub. Date: Jan. 26, 2017

(54) METHOD FOR COATING INTERNAL PASSAGES OF AN ARTICLE

(71) Applicants: RICHARD L. RIGGS, OLEY, PA (US); GREGORY D. WOOD, FLEETWOOD, PA (US); MARK J. REINSMITH, BREINGSVILLE, PA (US)

(72) Inventors: RICHARD L. RIGGS, OLEY, PA (US); GREGORY D. WOOD, FLEETWOOD, PA (US); MARK J. REINSMITH, BREINGSVILLE, PA (US)

(73) Assignee: MESTEK, INC., WESTFIELD, MA (US)

(21) Appl. No.: 15/215,863

(22) Filed: Jul. 21, 2016

Related U.S. Application Data
(60) Provisional application No. 62/196,413, filed on Jul. 24, 2015.

(51) Int. Cl. B05D 7/22; B05D 3/00

(52) U.S. Cl. CPC B05D 7/22; B05D 3/007

(57) ABSTRACT

A method for coating an article includes preheating the article to a first temperature to burn off impurities, cooling the article to a second temperature, coating the article with a coating, drying and heat-treating the article to solidify the coating.

### CROSS REFERENCE TO RELATED APPLICATIONS

This application is a U.S. Nonprovisional Patent Application claiming the benefit of U.S. Provisional Application Ser. No. 62/196,413, which is herein incorporated by reference in their entireties.

### FIELD OF THE INVENTION

The present invention relates generally to ceramic coatings and, more particularly, to a method for coating the internal passages and surfaces of a cast iron casting.

### BACKGROUND OF THE INVENTION

In metal working, casting involves pouring liquid metal into a mold, which often contains a sand core infused with organic or inorganic binders to produce a hollow cavity of the desired shape, and then allowing the metal to cool and solidify while the sand core becomes free flowing and is removed. The solidified part is also known as a casting, which is ejected or broken out of the mold to complete the process. Casting is most often used for making complex shapes that would be difficult or uneconomical to make by other methods. Cast iron is a popular choice for a casting material because of its relatively low melting point, good fluidity, castability, machinability, resistance to deformation and wear resistance. Indeed, cast iron castings have a wide range of applications and are used in pipes, machines, automotive industry parts and the like.

Cast iron does tend to oxidize and rust, however, when exposed to humidity and oxygen in the air. This can limit the ability of cast iron to be utilized for certain applications, such as in water treatment and distribution products which must meet certain established standards for any equipment that comes into contact with either potable water or products that support the production of potable water. While cast iron castings may be finished with barrier coatings intended to prevent the casting from rusting, in order to comply with established standards, doing so is not always practicable. For example, applying ceramic finish coatings to cast iron typically requires an initial cleaning of the surfaces to be coated by shot blasting such surfaces with an abrasive material and/or water. Where the surfaces to be coated are located deep within a part or not accessible, such as in water heater and boiler headers, flanges, valves and other parts, shot blasting to clean such surfaces may be impossible. Accordingly, as the surfaces can't be cleaned, they cannot be properly coated.

This has necessitated the use of alternative materials such as stainless steel and bronze, among others, which already meet established standards without the need for coating. Such alternative materials are often much more expensive than cast iron, however, which is undesirable for manufacturers and consumers alike.

In view of the above, there is a need for a method for coating the internal passageways and surfaces of cast iron parts to expand the range of applications for which such castings may be utilized.

### SUMMARY OF THE INVENTION

It is an object of the present invention to provide a method for coating the internal passages of an article.

It is another object of the present invention to provide a method for coating the internal passages of an article formed from cast iron.

It is another object of the present invention to provide a method for coating the internal passages of a cast iron article with a ceramic vitreous coating.

It is another object of the present invention to provide a method for coating the internal passages of a cast iron article to comply with established standards for water system components.

It is another object of the present invention to provide a method for coating the internal passages of a cast iron article to comply with NSF/ANSI Standard 61.

These and other objects are achieved by the present invention.

According to one embodiment of the present invention, a method for coating the internal passages of an article is provided. The method includes heating the article to a first temperature to burn off any impurities, cooling the article to a second temperature, coat the article with a coating, heat the coated part to drive off any moisture inherent to the coating process, raise the temperature to normalize the part just below the melting point, raise the temperature above the melting point and slowly cool the part back below the melting point to solidify the coating.

### BRIEF DESCRIPTION OF THE DRAWINGS

The present invention will be better understood from reading the following description of non-limiting embodiments, with reference to the attached drawings, wherein below:

FIG. 1 is a flow diagram of a method for coating the internal passages of an article, according to an embodiment of the present invention.

FIG. 2 is a flow diagram illustrating a heat treatment process of the coating method of FIG. 1.

### DETAILED DESCRIPTION OF THE PREFERRED EMBODIMENT

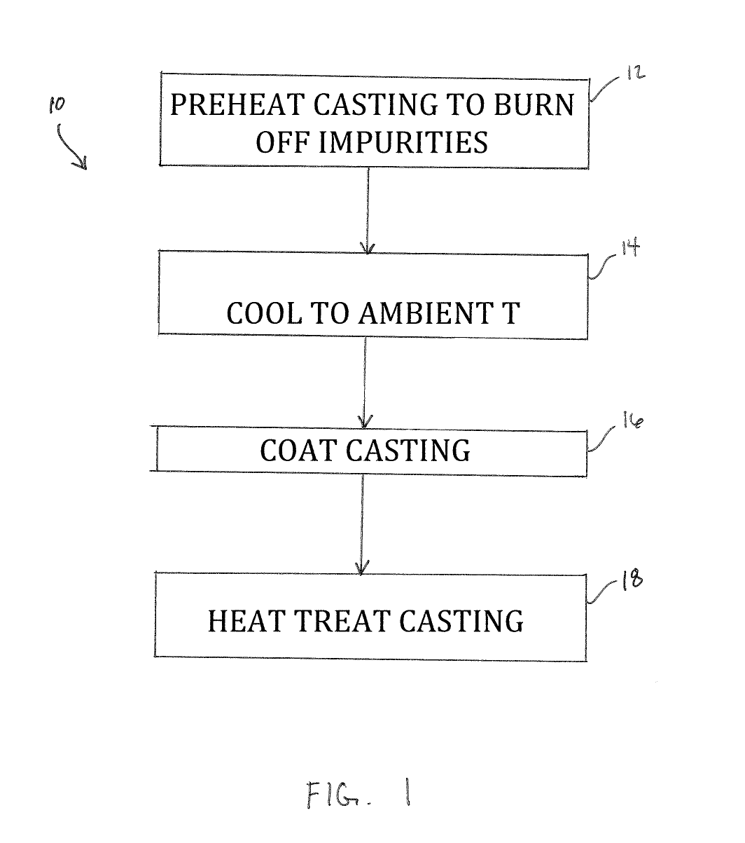

Referring to FIG. 1, a flow diagram of a method 10 for coating the internal passages and surfaces of an article is illustrated. In the preferred embodiment, the article is a casting made from cast iron. The casting may be manufactured utilizing any casting process commonly known in the art and generally includes pouring liquid metal, such as iron, into a mold, which contains a sand core infused with organic or inorganic binders to produce a hollow cavity of a desired shape, and then allowing it to cool and solidify. The casting may have internal cavities or passageways and may be designed for use in a variety of applications. For example, the casting may be a component part of a water heater or a boiler, such as a header, flange, valve or the like, but the present invention is not intended to be so limited in this regard. In particular, it is contemplated that the method 10 of the present invention may be utilized to coat any cast iron component or article, regardless of the particular process by which it is formed or the shape or configuration it may take.

As illustrated in FIG. 1, once the casting is formed by known processes, it is preheated, at step 12, to a temperature sufficient to burn off impurities that may migrate out of the casting during the subsequent coating and heat treatment procedures. In particular the casting is heat treated at step 12 to burn off any impurities on the internal surfaces and passageways of the casting. Preferably, the casting is preheated to approximately 1650° F. (for 1-1.5 hours) in an oven to burn off such impurities. At step 14 the casting is removed from the furnace and left to air cool back to an ambient condition. Alternatively, the casting may be soaked in a water bath to cool back to such ambient condition. Importantly, by bringing the casting up to a temperature just beyond where target impurities are burned off, the internal passages and surfaces are essentially “cleaned.” This has heretofore not been possible using existing shot-blasting cleaning methods because the tight and irregular internal passageways could not be accessed for cleaning.

At step 16, the casting is then coated with a vitreous coating solution or frit. In particular, the casting is blocked and fixtured to enable coating of all interior surfaces, including irregular interior surfaces. Once the interior of the casting is filled with the coating solution, it is held in this state for approximately two minutes, then drained. After draining, the casting is set into a positioning fixture on a vibrating table, which is then vibrated for approximately 5 minutes. The casting is then removed and air-dried. In an embodiment, the coating step may further include cleaning excess material from the exterior of the casting such as, for example, using a wire brush attached to a drill. Other methods may also be utilized. In an embodiment, the coating solution/frit may be any coating solution commonly used in the art for creating a ceramic finish coating on cast iron castings.

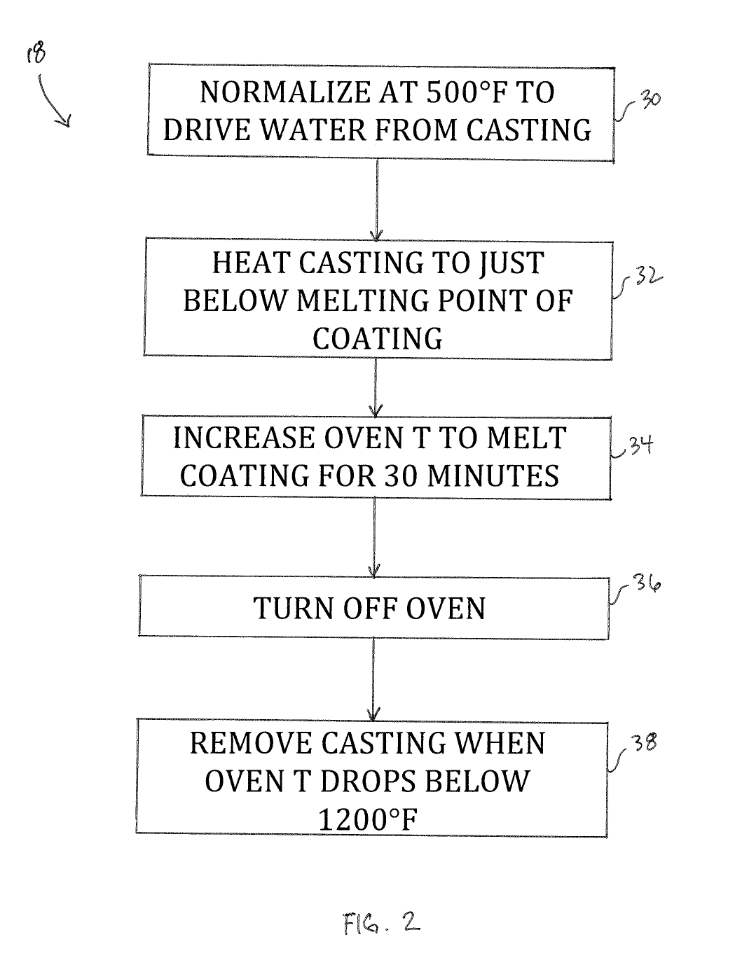

With further reference to FIG. 1, at step 18, the casting and coating are then heat treated to dewater the casting and to solidify and cure the coating. Referring now to FIG. 2, in an embodiment, the step 18 of heat treating the casting includes, at step 30, normalizing the casting at approximately 500° F. for approximately 1 hour to dewater the casting and the coating and, at step 32, moving the casting to a preheated oven and heating to just below the melting point of the coating. In an embodiment, the oven is preheated to approximately 1200° F. and the casting is held in the oven for approximately ½ hour. As discussed above, the purpose of this step is to get the casting and coating to a temperature just below its melting point throughout the batch. At step 34, the temperature within the oven is increased to a point above the melting point of the coating, for example, to approximately 1450° F., for approximately 30 minutes. Importantly, the temperature of the oven/furnace is kept below 1550° F. at all times. This is necessary to prevent the creation of voids within the coating. At step 36, the oven is then turned off and, at step 38, the casting is removed once the oven temperature drops below approximately 1200° F.

Importantly, the method 10 of the present invention can be utilize to produce glass-lined cast iron castings that meet NSF/ANSI Standard 61 for drinking water system components. Indeed, the method 10 of the present invention can be utilized to coat any complex, irregular internal passages and/or surfaces of cast iron components, which has heretofore not been possible due to the inability to access the internal passages and surfaces for necessary cleaning prior to coating. Accordingly, the glass-lined cast iron castings of the present invention can be utilized in place of components that customarily had to be manufactured from materials that were inherently compliant with industry standards, but which were much more expensive. As a result, the overall cost of components, and the systems such as, for example, water heaters and boilers that utilize such components, may be decreased.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A method for coating an article, comprising the steps of:
preheating the article to a first temperature to burn off impurities;
cooling the article to a second temperature;
coating the article with a coating; and
heat-treating the article to solidify the coating.

2. The method according to claim 1, wherein:
the article is a cast iron casting having at least one internal passageway.

3. The method according to claim 2, wherein:
the first temperature is approximately 1200° F.

4. The method according to claim 2, wherein:
the first temperature is approximately 1650° F.

5. The method according to claim 2, wherein:
the second temperature is approximately ambient temperature.

6. The method according to claim 2, wherein:
the step of coating the article includes filling the casting with the coating, draining the casting, vibrating the casting and air-drying the casting.

7. The method according to claim 6, wherein:
the step of coating the article further includes cleaning excess material from the exterior of the casting.

8. The method according to claim 2, wherein:
the step of heat treating the article includes normalizing the casting to drive water from the casting, moving the casting to a preheated oven, and heating the casting to a third temperature just below a melting point of the coating.

9. The method according to claim 8, wherein:
the step of heat treating the article further includes increasing the temperature within the oven to a fourth temperature for approximately 25 to 30 minutes, turning off the oven, and removing the casting once the oven the temperature drops below approximately the third temperature.

10. The method according to claim 9, wherein:
the third temperature is approximately 1200° F.

11. The method according to claim 9, wherein:
the fourth temperature is approximately 1450° F.

12. A method for coating a cast iron article, comprising the steps of:
preheating a cast iron article to a first temperature to burn off impurities;
cooling said cast iron article to a second temperature;
coating said cast iron article with a solution;
vibrating said cast iron article containing said solution;
heat-treating said cast iron article to solidify the coating.

13. The method according to claim 12, wherein:
said cast iron article having at least one internal passageway.

14. The method according to claim 13, wherein:
the step of heating-treating includes normalizing said cast iron article to drive water from the casting, moving said cast iron article to a preheated oven, and heating said cast iron article to a third temperature just below a melting point of the coating.

15. The method according to claim 14, wherein:
the step of heat treating said cast iron article further includes increasing the temperature within the oven to a fourth temperature for approximately 25 to 30 minutes, turning off the oven, and removing said cast iron article once the oven the temperature drops below approximately said third temperature.

16. The method according to claim 12, wherein:
said first temperature is approximately 1650° F.

17. The method according to claim 12, wherein:
said second temperature is approximately ambient temperature.

18. The method according to claim 14, wherein:
said third temperature is approximately 1200° F.

19. The method according to claim 15, wherein:
said fourth temperature is approximately 1450° F.
